(19) United States
(12) Patent Application Publication
(10) Pub. No.: US 2026/0077577 A1
(43) Pub. Date: Mar. 19, 2026

(54) METHOD FOR MANUFACTURING METAL SOLID-TO-METAL SOLID BONDED BODY, AND COMPOSITE MEMBER

(71) Applicant: TOHOKU UNIVERSITY, Sendai-shi (JP)

(72) Inventors: Hidemi KATO, Sendai-shi (JP); Kota Kurabayashi, Sendai-shi (JP); Yasuke Ohashi, Sendai-shi (JP)

(73) Assignee: TOHOKU UNIVERSITY, Sendai-shi (JP)

(21) Appl. No.: 19/398,635

(22) Filed: Nov. 24, 2025

(30) Foreign Application Priority Data
Nov. 26, 2021 (JP) 2024-205474

(51) Int. Cl. B32B 37/04; B32B 15/01; B32B 37/06; B32B 37/10

(52) U.S. Cl. CPC B32B 37/04; B32B 15/01; B32B 37/06; B32B 37/10; B32B 2309/12

(57) ABSTRACT

A method for manufacturing a metal solid-to-metal solid bonded body, capable of improving a bond strength on a bonding face, and a composite member. A solid metal body containing a first component is brought into contact with a solid metal material composed of a compound, an alloy, or a non-equilibrium alloy, which contains both a second component and a third component having positive and negative heats of mixing respectively relative to the first component, and heated at a predetermined temperature for a predetermined time while applying a predetermined pressure to between the metal body and the metal material. Thereby, the first component and the third component are interdiffused with each other, and a liquid alloy containing the first component and the third component, which has been generated in a region where the first component and the third component have interdiffused with each other, is discharged.

### DESCRIPTION

### Field Of The Invention

The present invention relates to a method for manufacturing a metal solid-to-metal solid bonded body, and a composite member.

### Description of Related Art

As a method for manufacturing a metal solid-to-metal solid bonded body, the present inventors have developed a dealloying method, in which a solid metal body composed of a first component is brought into contact with a solid metal material composed of a compound, an alloy, or a non-equilibrium alloy, which contains both a second component and a third component having positive and negative heats of mixing respectively relative to the first component, and heated at a predetermined temperature for a predetermined time, so that the first component and the third component interdiffuse (for example, see Patent Literature 1). This method is a method for manufacturing a nanocomposite metal member based on a metallurgical technique, but can also be used as a method for manufacturing a metal solid-to-metal solid bonded body, because the first component in the metal body and the third component in the metal material interdiffuse by heat treatment so that the metal body and the metal material are bonded to each other.

As a bonding method using the dealloying method described in Patent Literature 1, for example, iron (Fe) and magnesium (Mg) immiscible with each other are bonded to each other by the present inventors (for example, see Non-Patent Literature 1). In other words, an Fe₁₀₀₋ₓNiₓ layer is bonded to a surface of Fe by diffusion bonding, then Mg is brought into contact with a surface of the Fe₁₀₀₋ₓNiₓ layer so as to sandwich the Fe₁₀₀₋ₓNiₓ layer, and then the Fe₁₀₀₋ₓNiₓ layer and Mg are bonded to each other by the method described in Patent Literature 1, so that Fe and Mg are bonded to each other.

### CITATION LIST

### Patent Literature

Patent Literature 1: Japanese Patent Publication No. 6710707

### Non-Patent Literature

Non-Patent Literature 1: Kota Kurabayashi, Takeshi Wada, Hidemi Kato, “Dissimilar Joining of Immiscible Fe—Mg using Solid Metal Dealloying”, Scripta Materialia, 2023, 230, 115404

### SUMMARY OF THE INVENTION

### Problem to be Solved

In the bonding between Fe and Mg described in Non-Patent Literature 1, it was confirmed that, when the Fe₁₀₀₋ₓNiₓ layer contained a sufficient amount of Ni (x>30, unit: at %), Ni and Mg interdiffused with each other between the Fe₁₀₀₋ₓNiₓ layer and Mg, to form a composite metal member. However, there has been a problem that, under a condition of 30<x<50, a bond strength is high, meanwhile, under a condition of x>60, a large amount of brittle intermetallic compound Mg₂Ni is formed, resulting in a low bond strength on the bonding face.

The present invention was made with a focus on the above problem, and an object of the present invention is to provide a method for manufacturing a metal solid-to-metal solid bonded body, capable of improving a bond strength on a bonding face, and a composite member.

### Solution to Problem

To achieve the above object, the present inventors examined the reaction process in the bonding in Non-Patent Literature 1 using the dealloying method described in Patent Literature 1 in detail. As a result, the present inventors found that the first component (Mg) of the metal body and the third component (Ni) of the metal member (FeNi) were eutectically reacted with each other by a heat treatment to melt the contact face to generate a liquid containing the first and third components (Mg—Ni liquid), thereby enhancing the progression of the dealloying reaction as a liquid phase diffusion with a high diffusing capacity. Based on this finding, the present inventors conducted further investigations, leading to the present invention.

That is, the method for manufacturing a metal solid-to-metal solid bonded body according to the present invention is characterized in that a solid metal body containing a first component is brought into contact with a solid metal material composed of a compound, an alloy, or a non-equilibrium alloy, which contains both a second component and a third component having positive and negative heats of mixing respectively relative to the first component, and heated at a predetermined temperature for a predetermined time while applying a predetermined pressure between the metal body and the metal material, so that the first component and the third component are interdiffused with each other, and a liquid alloy containing the first component and the third component, which has been generated in a region where the first component and the third component have interdiffused with each other, is discharged.

In the method for manufacturing a metal solid-to-metal solid bonded body according to the present invention, a solid metal body and a solid metal material are brought into contact with each other and heated, so that the third component diffuses from the metal material into the metal body and the first component diffuses from the metal body into the metal material in a mutual manner, depending on the heat of mixing with the first component of the metal body. The second component does not diffuse into the metal body side. Thereby, it is possible to form a co-continuous structure with portions having the first and third components and portions having the second component finely intertangled with each other on the order of nanometers or micrometers in a region on the metal material side where the first and third components have interdiffused with each other.

In this case, a component eutectically reactable with the first component at the above-described predetermined temperature is used as the third component, so that the first and third components are eutectically reacted with each other to generate a liquid alloy containing the first and third components in the region where the first and third components have interdiffused with each other. Herein, if the generated liquid alloy remains and solidifies, it becomes brittle, and therefore the bond strength of the bonding part between the metal body and the metal material is decreased. Thus, in the method for manufacturing a metal solid-to-metal solid bonded body according to the present invention, the generated liquid alloy is discharged to the outside by applying a predetermined pressure while performing heat treatment, to prevent the bonding part from decreasing in the bond strength. In this way, the method for manufacturing a metal solid-to-metal solid bonded body according to the present invention makes it possible to increase the bond strength compared to a case that no predetermined pressure is applied. Since the liquid alloy that becomes brittle by solidification is discharged to the outside, ductility can also be improved.

In the method for manufacturing a metal solid-to-metal solid bonded body according to the present invention, since the bonding part between the metal body and the metal material is molten by the eutectic reaction between the first component and the third component, the interdiffusion between the first component and the third component can be performed in a liquid phase. Thereby, progression of the interdiffusion between the first component and the third component can be enhanced, and the bonding time can be shortened compared to solid phase diffusion.

In the method for manufacturing a metal solid-to-metal solid bonded body according to the present invention, it is preferable that the liquid alloy does not contain the second component, but may contain, besides the first component and the third component, components other than the second component. Furthermore, for forming the liquid alloy when the solid metal body and the solid metal material are brought into contact with each other, it is preferable that the liquid alloy has a melting point or liquidus temperature lower than the melting point of the metal body. The liquid alloy may contain, for example, what becomes, after the solidification, an intermetallic compound containing the first component and the third component bonded to each other.

In the method for manufacturing a metal solid-to-metal solid bonded body according to the present invention, the temperature is not necessarily raised to a temperature above the melting point of the metal body or the metal material by utilizing the interdiffusion between the solids through the eutectic reaction. For this reason, the predetermined temperature during the heat treatment is preferably lower than the melting points of the metal body and the metal material and higher than the melting point or liquidus temperature of the liquid alloy. Thereby, the heating temperature required for the bonding can be lowered and the heating time and cost can be reduced compared to a case of heating at the melting point or higher.

In the method for manufacturing a metal solid-to-metal solid bonded body according to the present invention, the predetermined pressure described above is preferably 10 MPa or higher, more preferably 20 MPa or higher. This pressure makes it possible to discharge more liquid alloy to the outside to decrease the residual amount of the liquid alloy, resulting in a high bond strength. It is preferable to discharge the liquid alloy to the outside from a range covering from a boundary between a region on the metal body side where the third component has diffused, i.e., a region on the metal body side containing no third component and a region containing the third component, to a boundary between the metal body and the metal material (bonding face), in the region where the first component and third component have interdiffused with each other. After the discharge, the liquid alloy may adhere to the periphery of the bonded body with the metal body and the metal material bonded to each other.

In the method for manufacturing a metal solid-to-metal solid bonded body according to the present invention, it is preferable that the first component is composed of at least one of Li, Mg, Ca, Cu, Zn, Ag, Pb, Bi, and a rare earth metal element; the metal body is composed of the first component alone, or a mixture that is an alloy, a compound, or a non-equilibrium alloy, which contains the first component as a main component; the second component is composed of at least one of Ti, Zr, Hf, Nb, Ta, Cr, V, Mo, W, Fe, Co, Ni, C, Si, Ge, and Sn; the third component is composed of at least one of Li, Mg, Ca, Mn, Fe, Co, Ni, Cu, Ti, Zr, Hf, Nb, Ta, Cr, Mo, and W; and the metal material is composed of a mixture that is an alloy, a compound, or a non-equilibrium alloy, which contains both the second component and the third component.

Specifically, for example, the first component may be composed of Mg; the metal body may be composed of the first component alone, or a mixture that is an alloy, a compound, or a non-equilibrium alloy, which contains the first component as a main component; the third component may be composed of Ni; and the metal material may be an Fe-containing alloy. Alternatively, the first component may be composed of Mg; the metal body may be composed of the first component alone, or a mixture that is an alloy, a compound, or a non-equilibrium alloy, which contains the first component as a main component; the third component may be composed of Cu; and the metal material may be a Ti-containing alloy. Note that the main component refers to a component in the largest amount among the components contained in the metal body or metal material.

The method for manufacturing a metal solid-to-metal solid bonded body according to the present invention makes it possible to bond solid metals that are normally difficult to bond to each other, by utilizing interdiffusion between the solids. For two solid metals directly unbondable to each other, one solid metal is prepared as a metal body, and the other solid metal with a surface bonded with the metal material is prepared, and the metal body and metal material are bonded using the method for manufacturing a metal solid-to-metal solid bonded body according to the present invention, so that the two solid metals can be bonded. Also in this case, after bonding the metal body (one solid metal) and the metal material, the other solid metal may be bonded to the metal material. Alternatively, for two solid metals directly unbondable with each other, one solid metal is prepared as a metal material, and the other solid metal with a surface bonded with the metal body is prepared, and the metal body and metal material are bonded using the method for manufacturing a metal solid-to-metal solid bonded body according to the present invention, so that the two solid metals can be bonded. Also, in this case, after bonding the metal body and the metal material (one solid metal), the other solid metal may be bonded to the metal body.

The method for manufacturing a metal solid-to-metal solid bonded body according to the present invention makes it possible to manufacture a composite member having a co-continuous structure with portions composed of the first and third components and portions composed of the second component finely intertangled with each other on the order of nanometers or micrometers in a region on the metal material side where the first and third components have interdiffused with each other.

The method for manufacturing a bonded body according to the present invention is characterized in that a solid metal body containing Mg or an Mg alloy is brought into contact with a solid metal material containing an Ni and Fe-containing alloy or a Ti and Cu-containing alloy, and the metal body and the metal material are heated while applying a pressure to between the metal body and the metal material to bond the metal body and the metal material to each other.

In the method for manufacturing a bonded body according to the present invention, a solid metal body and a solid metal material are brought into contact with each other and heated, so that Ni or Cu diffuses from the metal material into the metal body and Mg diffuses from the metal body into the metal material in a mutual manner. Ti does not diffuse to the metal body side. Thereby, it is possible to form a co-continuous structure with portions having Mg and Ni or Cu and portions having Ti finely intertangled with each other on the order of nanometers or micrometers in a region on the metal material side where Mg and Ni or Cu have interdiffused with each other.

In this case, Mg and Ni or Cu are eutectically reacted in the region where Mg and Ni or Cu have interdiffused with each other, to produce a liquid alloy containing Mg and Ni or Cu. Herein, if the generated liquid alloy solidifies, it becomes brittle, and therefore the bond strength of the bonding part between the metal body and the metal material is decreased. Thus, in the method for manufacturing a bonded body according to the present invention, the generated liquid alloy is discharged to the outside by applying a pressure while performing heat treatment, so that the bonding part can be prevented from decreasing in the bond strength, and the bond strength can be improved. Also, the ductility can be improved.

Furthermore, in the method for manufacturing the bonded body according to the present invention, since the eutectic reaction between Mg and Ni or Cu causes the contact part between the metal body and the metal material to melt, the interdiffusion between Mg and Ni or Cu can be performed in a liquid phase. Thereby, progression of the interdiffusion between Mg and Ni or Cu can be enhanced, and the bonding time can be shortened compared to solid phase diffusion.

In the method for manufacturing a bonded body according to the present invention, the metal body is an alloy containing Mg, Zn, and Y or Zr, or an alloy containing Mg, Al, and Zn, and the metal material may contain Fe₁₀₀₋ₓNiₓ (30≤x≤70, unit: at %), or Ti_{100-y}Cu_{y} (30≤y≤70, unit: at %).

Furthermore, in the method for manufacturing a bonded body according to the present invention, an Fe alloy or Ti alloy may be bonded to the metal material such that the metal material is interposed between the metal body and the alloy. In this case, solid metals directly unbondable with each other can be bonded to each other via the interposed metal material. Any one of the two solid metals to be bonded to each other via the metal material may be first bonded to the metal material. Preferably, the Fe alloy is carbon steel or stainless steel. Preferably, the Ti alloy contains Ti and at least one of Al, V, Nb, Ni, Cr, and Sn.

Furthermore, in the method for manufacturing a bonded body according to the present invention, a metal or alloy having a composition different from that of the metal material and containing at least one of Mg, Zn, Y, Zr, and Al may be bonded to the metal body such that the metal body is interposed between the metal material and the metal or alloy. Also, in this case, solid metals directly unbondable with each other can be bonded to each other via the interposed metal body. Any one of the two solid metals to be bonded to each other via the metal body may be first bonded to the metal body.

The composite member according to the present invention has a solid metal body containing the first component, and a co-continuous structure with portions containing the first component and the third component having a negative heat of mixing relative to the first component and portions containing the second component having a positive heat of mixing relative to the first component, intertangled with each other on the order of nanometers or micrometers. The co-continuous structure is characteristically bonded to the surface of the metal body.

In the composite member according to the present invention, the third component is preferably composed of a material that is eutectically reactable with the first component at a temperature lower than the melting point of the metal body. It is preferable that, in the composite member according to the present invention, the first component is composed of at least one of Li, Mg, Ca, Cu, Zn, Ag, Pb, Bi, and a rare earth metal element; the metal body is composed of the first component alone, or a mixture that is an alloy, a compound, or a non-equilibrium alloy, which contains the first component as a main component; the second component is composed of at least one of Ti, Zr, Hf, Nb, Ta, Cr, V, Mo, W, Fe, Co, Ni, C, Si, Ge, and Sn; the third component is composed of at least one of Li, Mg, Ca, Mn, Fe, Co, Ni, Cu, Ti, Zr, Hf, Nb, Ta, Cr, Mo, and W.

The composite member according to the present invention has a solid metal material composed of a compound, an alloy, or a non-equilibrium alloy containing both the second component and the third component, and the metal material may be bonded to the metal body such that the co-continuous structure is interposed between the metal material and the metal body.

When the composite member has this metal material, the first component may be composed of Mg; the metal body may be composed of the first component alone, or a mixture that is an alloy, a compound, or a non-equilibrium alloy, which contains the first component as a main component; the third component may be composed of Ni; and the metal material may be an Fe-containing alloy. Alternatively, the first component may be composed of Mg; the metal body may be composed of the first component alone, or a mixture that is an alloy, a compound, or a non-equilibrium alloy, which contains the first component as a main component; the third component may be composed of Cu; and the metal material may be a Ti-containing alloy.

In these cases, the metal body is an alloy containing Mg, Zn, and Y or Zr, or an alloy containing Mg, Al, and Zn, and the metal material may contain Fe₁₀₀₋ₓNiₓ (30≤x≤70, unit: at %), or Ti_{100-y}Cu_{y} (30≤y≤70, unit: at %). In this case, the composite member may have an Fe alloy or Ti alloy bonded to the metal material such that the metal material is interposed between the metal body and the alloy, and may have a metal or an alloy with a composition different from that of the metal material, which is bonded to the metal body such that the metal body is interposed between the metal material and the metal or the alloy, and containing at least one of Mg, Zn, Y, Zr, and Al. In this case, the Fe alloy is preferably carbon steel or stainless steel. Furthermore, the Ti alloy preferably contains Ti and at least one of Al, V, Nb, Ni, Cr, and Sn.

The composite member according to the present invention can be suitably manufactured by the method for manufacturing a metal solid-to-metal solid bonded body according to the present invention or the method for manufacturing a bonded body according to the present invention.

### Effects of Invention

The present invention makes it possible to provide a method for manufacturing a metal solid-to-metal solid bonded body, capable of improving a bond strength on a bonding face, and a composite member.

### BRIEF DESCRIPTION OF THE DRAWINGS

FIG. 1 shows diagrams after diffusion bonding between Ti and Ti₁₀₀₋ₓCuₓ in a method for manufacturing a metal solid-to-metal solid bonded body according to an embodiment of the present invention, in which FIG. 1(a) upper figure is an SEM (scanning electron microscope) image in the vicinity of the bonded interface under a condition of x=65, FIG. 1(a) lower figure shows a result of an EDX (energy dispersive X-ray) analysis along a line in the SEM image, FIG. 1(b) is an SEM image in the vicinity of the bonded interface under conditions of x=33 and 50, and FIG. 1(c) shows X-ray diffraction (XRD) spectra of the Ti—Cu layer surface under conditions of x=33, 50, and 65.

FIG. 2 shows diagrams related to a bonded body obtained by the method for manufacturing a metal solid-to-metal solid bonded body according to the embodiment of the present invention, in which FIG. 2(a) upper figure is an SEM image in the vicinity of the bonded interface between Ti₁₀₀₋ₓCuₓ (x=50) and Mg, FIG. 2(a) lower figure shows an EDX analysis result along the line in the SEM image of the upper figure, FIG. 2(b) upper figure is an enlarged SEM image of a solidified microstructure in an Mg—Cu phase in the SEM image of FIG. 2(a), FIG. 2(b) lower figure is a Cu—Mg binary equilibrium diagram, FIG. 2(c) upper figure is an SEM image of a boundary region between a Ti₂Cu/Mg—Cu phase and an α-Ti/Mg—Cu phase in the SEM image of FIG. 2(a), and FIG. 2(c) lower figure shows an EDX analysis result along the line in the SEM image of the upper figure.

FIG. 3 is an explanatory diagram showing a reaction flow in the method for manufacturing a metal solid-to-metal solid bonded body according to the embodiment of the present invention, shown in FIG. 2.

FIG. 4 shows a graph indicating a change in a thickness of a layer composed of the Mg—Cu phase (Mg—Cu layer) relative to a bonding pressure on the bonded interface between Ti₁₀₀₋ₓCuₓ (x=33, 50, 65) and Mg in the bonded body obtained by the method for manufacturing a metal solid-to-metal solid bonded body according to the embodiment of the present invention; in which an insert image includes an SEM image in the vicinity of the bonded interface at a bonding pressure of 1 MPa under a condition of X=33, an SEM image in the vicinity of the bonded interface at a bonding pressure of 20 MPa, and an appearance of a lateral face after cooling at a bonding pressure of 20 MPa.

FIG. 5 shows diagrams related to a bonded body obtained at a bonding pressure of 20 MPa in the vicinity of the bonded interface between Ti₁₀₀₋ₓCuₓ (x=65) and Mg in the method for manufacturing a metal solid-to-metal solid bonded body according to an embodiment of the present invention, in which FIG. 5(a) is an SEM image, FIG. 5(b) shows an EDX analysis result along the line in the SEM image of FIG. 5(a), FIG. 5 (c) is an SEM image showing an enlarged area (c) in the SEM image of FIG. 5(a), and FIG. 5(d) is SEM image showing an enlarged area (d) in the SEM image of FIG. 5(a).

FIG. 6 shows diagrams related to a bonded body of Ti₁₀₀₋ₓCuₓ and Mg obtained at a bonding pressure of 0.2 MPa or 20 MPa by the method for manufacturing a metal solid-to-metal solid bonded body according to the embodiment of the present invention, in which FIG. 6(a) is a plan view showing a shape of a tensile test specimen, FIG. 6(b) is a graph showing a result of the tensile test under a condition of x=33, 40, 50, and 65.

FIG. 7 shows diagrams related to a bonded body obtained at a bonding pressure of 20 MPa in the vicinity of the bonded interface between Ti₁₀₀₋ₓCuₓ (x=50) and Mg in the method for manufacturing a metal solid-to-metal solid bonded body according to the embodiment of the present invention, in which FIG. 7(a) is a load-displacement curve created using an ultra-microhardness tester for the co-continuous microstructure composed of Ti, Mg, and α-Ti/Mg—Cu phase, and includes insert images of a microscopic photograph of indenter marks on the co-continuous microstructure (“Ti/Mg composite” in the figure), and FIG. 7(b) is a graph indicating an indentation hardness Hᵢₜ determined from FIG. 7(a).

FIG. 8 shows diagrams related to a flow of a bonding experiment method for Fe₁₀₀₋ₓNiₓ (x=50) and KUMADAI magnesium alloy in the method for manufacturing a metal solid-to-metal solid bonded body according to the embodiment of the present invention, in which FIG. 8(a) shows a method of bonding S45C with Fe₁₀₀₋ₓNiₓ in the first stage, FIG. 8(b) shows a method of bonding Fe₁₀₀₋ₓNiₓ and KUMADAI magnesium alloy in the second stage, and FIG. 8(c) shows a tensile test method.

FIG. 9(a) is an SEM image in the vicinity of a bonded interface between S45C and Fe₁₀₀₋ₓNiₓ after the first stage in FIG. 8(a), FIG. 9(b) is an enlarged SEM image of a part of FIG. 9(a), FIG. 9(c) shows an Fe surface analysis result of EDX in the range of FIG. 9(b), FIG. 9(d) shows an Ni surface analysis result, FIG. 9(e) shows an Mn surface analysis result, and FIG. 9(f) shows a line analysis result of EDX along the line of the SEM image in FIG. 9(a).

FIG. 10(a) is an appearance image of the bonded body of Fe₁₀₀₋ₓNiₓ and KUMADAI magnesium alloy after the second stage in FIG. 8(b), FIG. 10(b) is an SEM image in the vicinity of the bonded interface, and FIG. 10(c) is an enlarged SEM image of a part of FIG. 10(b).

FIG. 11 shows images related to EDX in the range of FIG. 10(c), in which FIG. 11(a) shows an Mg surface analysis result, FIG. 11(b) shows an Fe surface analysis result, FIG. 11(c) shows a Zn surface analysis result, FIG. 11(d) shows a Y surface analysis result, FIG. 11(e) shows a Ni surface analysis result.

FIG. 12 shows images of the specimen fractured in the tensile test in FIG. 8(c), in which FIG. 12(a) is an SEM image on the KUMADAI magnesium alloy side, and FIG. 12(b) is an SEM image on the Fe₁₀₀₋ₓNiₓ side.

### DETAILED DESCRIPTION OF THE INVENTION

The embodiment of the present invention will be explained below with reference to the drawings and examples.

In the method for manufacturing a metal solid-to-metal solid bonded body according to the present invention, a solid metal body and a solid metal material are bonded to each other as follows.

In other words, first, a solid metal body and a solid metal material are prepared. The solid metal body contains a first component. The solid metal body is composed of the first component alone, or a mixture that is an alloy, a compound, or a non-equilibrium alloy, which contains the first component as a main component. The solid metal material is composed of a mixture that is a compound, an alloy, or a non-equilibrium alloy, which contains both a second component and a third component. The second component and the third component have positive and negative heats of mixing respectively relative to the first component. Furthermore, the third component is composed of a material that is eutectically reactable with the first component at a predetermined temperature.

Specifically, the first component is composed of at least one of Li, Mg, Ca, Cu, Zn, Ag, Pb, Bi, and a rare earth metal element. The second component is composed of at least one of Ti, Zr, Hf, Nb, Ta, Cr, V, Mo, W, Fe, Co, Ni, C, Si, Ge, and Sn. The third component is composed of at least one of Li, Mg, Ca, Mn, Fe, Co, Ni, Cu, Ti, Zr, Hf, Nb, Ta, Cr, Mo, and W.

Next, the metal body and the metal material are brought into contact with each other, and a predetermined pressure is applied to between the metal body and the metal material while performing a heat treatment at a predetermined temperature for a predetermined time. At this time, the predetermined temperature in the heat treatment is a temperature lower than the melting points of the metal body and the metal material and enough to generate a liquid alloy through a eutectic reaction between the first and third components, i.e., a temperature higher than the melting point or liquidus temperature of the liquid alloy.

Through the heat treatment, the third component diffuses from the metal material into the metal body and the first component diffuses from the metal body into the metal material in a mutual manner. At the same time, the first and third components eutectically react to generate a liquid alloy containing the first and third components in the region where the first and third components have interdiffused with each other. Note that the second component does not diffuse into the metal body side. Thereby, it is possible to form a co-continuous structure with portions having the first and third components and portions having the second component finely intertangled with each other on the order of nanometers or micrometers in a region on the metal material side where the first and third components have interdiffused with each other.

The resulting liquid alloy contains the first component and the third component but does not contain the second component. The alloy liquid may contain, besides the first component and the third component, components other than the second component. The liquid alloy contains, for example, what becomes, after the solidification, an intermetallic compound containing the first component and the third component that are bound to each other.

Herein, if the liquid alloy solidifies as it is, it becomes brittle, and therefore the bond strength of the bonding part between the metal body and the metal material is decreased. Thus, the generated liquid alloy is discharged to the outside by applying a predetermined pressure while performing heat treatment, to prevent the bonding part from decreasing in the bond strength. Specifically, the liquid alloy is discharged to the outside from a range covering from a boundary between a range on the metal body side where the third component has diffused, i.e., a region on the metal body side containing no third component and a region containing the third component, to a boundary between the metal body and the metal material (bonding face), in the region where the first component and third component have interdiffused with each other. For performing this bonding more effectively, the metal material has a thickness of preferably 500 μm or smaller, more preferably 200 μm or smaller, most preferably 100 μm or smaller. The lower limit value of the thickness is not particularly limited, but is 0.2 nm or larger, which is a range where the metal material can be manufactured. The liquid alloy may adhere to the periphery of the bonded body of the metal body and the metal material after the discharge.

As described above, the method for manufacturing a metal solid-to-metal solid bonded body according to the embodiment of the present invention makes it possible to bond solid metals that are normally difficult to bond to each other, by utilizing interdiffusion between the solids. This makes it possible to manufacture the bonded body that is a composite member according to the embodiment of the present invention. Furthermore, the method for manufacturing a metal solid-to-metal solid bonded body according to the embodiment of the present invention makes it possible to increase the bond strength compared to a case that no predetermined pressure is applied. Since the liquid alloy that becomes brittle by solidification is discharged to the outside, ductility can also be improved.

In the method for manufacturing a metal solid-to-metal solid bonded body according to the embodiment of the present invention, since the bonding part between the metal body and the metal material is molten by the eutectic reaction between the first component and the third component, the interdiffusion between the first component and the third component can be performed in a liquid phase. Thereby, progression of the interdiffusion between the first component and the third component can be enhanced, and the bonding time can be shortened compared to solid phase diffusion.

In the method for manufacturing a metal solid-to-metal solid bonded body according to the embodiment of the present invention, the temperature is not necessarily raised to not lower than the melting points of the metal body or the metal material, by utilizing the interdiffusion through the eutectic reaction between the solids. Thereby, the heating temperature required for the bonding can be lowered and the heating time and cost can be reduced compared to a case of heating the metal body or the metal material to the melting point or higher.

In the method for manufacturing a metal solid-to-metal solid bonded body according to the embodiment of the present invention, for two solid metals directly unbondable with each other, one solid metal is prepared as a metal body, and the other solid metal with a surface bonded with the metal material is prepared, and the metal body and metal material are bonded using the method for manufacturing a metal solid-to-metal solid bonded body according to the present invention, so that the two solid metals can be bonded to each other. Also in this case, after the bonding between the metal body (one solid metal) and the metal material, the other solid metal may be bonded to the metal material. Alternatively, for two solid metals directly unbondable with each other, one solid metal is prepared as a metal material, and the other solid metal with a surface bonded with the metal body is prepared, and the metal body and metal material are bonded using the method for manufacturing a metal solid-to-metal solid bonded body according to the present invention, so that the two solid metals can be bonded to each other. Also, in this case, after bonding the metal body and the metal material (one solid metal), the other solid metal may be bonded to the metal body.

### Example 1

A bonding experiment between Ti₁₀₀₋ₓCuₓ provided on a surface of Ti and Mg was implemented using the method for manufacturing a metal solid-to-metal solid bonded body according to the embodiment of the present invention. In this experiment, the first component is Mg, the second component is Ti, and the third component is Cu. In the experiment, samples of pure Mg (99.9 mass %) and pure Ti (99.9 mass %) having a diameter of 15 mm and a thickness of 15 mm, as well as a sample of Ti₁₀₀₋ₓCuₓ having a diameter of 10 mm and a thickness of 1.2 mm [x=33 to 65, unit: at % (the same applies to the following)] (Ti: 99.9 mass %, Cu: 99.99 mass %) were prepared. The Ti₁₀₀₋ₓCuₓ sample was prepared by an arc melting of Ti and Cu under a high-purity Ar atmosphere and a tilt casting into a round bar copper mold, followed by cutting.

In the experiment, in the first stage, one surface of the Ti sample and one surface of the Ti₁₀₀₋ₓCuₓ sample were butt-joined to each other at a pressure of 5 MPa, and in this state, the samples were high-frequency heated at 1073 K for 60 minutes in an argon flow multi-furnace, to diffusion-bond the Ti sample and the Ti₁₀₀₋ₓCuₓ sample to each other. Subsequently, in the second stage, the other surface of the Ti₁₀₀₋ₓCuₓ sample and one surface of the Mg sample were butt-joined to each other at a predetermined pressure (bonding pressure), and in this state, the samples were heated at a predetermined temperature (heating temperature) in an argon flow multi-furnace by the method for manufacturing a metal solid-to-metal solid bonded body according to the embodiment of the present invention, to bond the Ti₁₀₀₋ₓCuₓ sample and the Mg sample to each other.

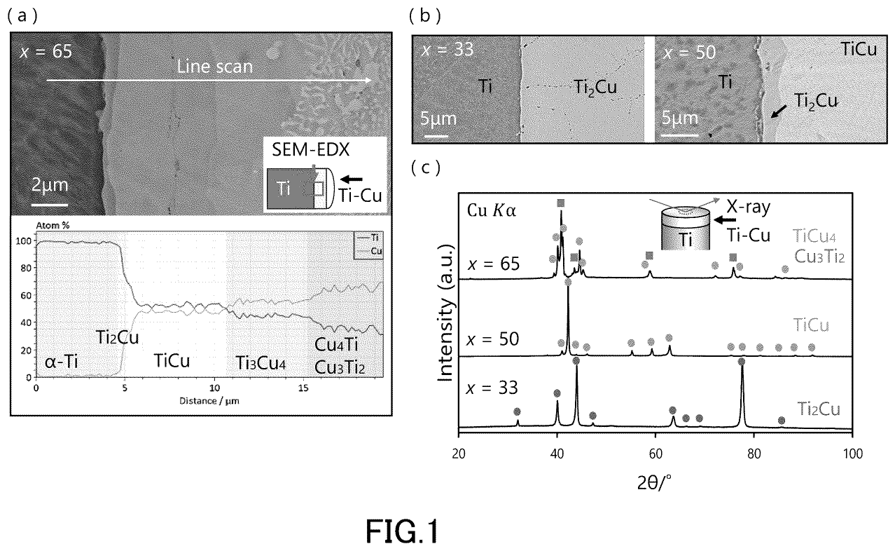

First, in the vicinity of the bonded interface after the diffusion bonding between Ti and Ti₁₀₀₋ₓCuₓ in the first stage, an SEM (scanning electron microscope) observation, an EDX (energy dispersive X-ray) analysis, and an XRD analysis were performed. As the scanning electron microscope, “Ultra55” manufactured by Carl Zeiss AG was used, and for the EDX analysis, “XFlash” manufactured by Bruker Corporation was used (the same applies to the following). FIG. 1(a) shows an SEM image in the vicinity of the bonded interface under a condition of x=65 and an EDX analysis result, FIG. 1(b) shows an SEM image under conditions of x=33 and 50, and FIG. 1(c) shows XRD spectra of the Ti—Cu layer surface under conditions of x=33, 50, and 65.

As shown in FIG. 1(a), formation of various compounds such as Ti₂Cu, TiCu, and Ti₃Cu₄ was confirmed in the Ti—Cu layer under the condition of x=65. As shown in FIG. 1(b), formation of only Ti₂Cu was confirmed in the Ti—Cu layer under the condition of x=50, and formation of only Ti₂Cu and TiCu was confirmed in the Ti—Cu layer under the condition of x=33. On the bonded interface, no voids or defective bonding were observed, indicating sufficient diffusion bonding. Furthermore, as shown in FIG. 1(c), on the surface of the Ti—Cu layer, formation of Ti₂Cu was confirmed under the condition of x=33, formation of TiCu was confirmed under the condition of x=50, and formation of TiCu₄ and Ti₂Cu₃ was confirmed under the condition of x=65. These layers are all brittle intermetallic compounds.

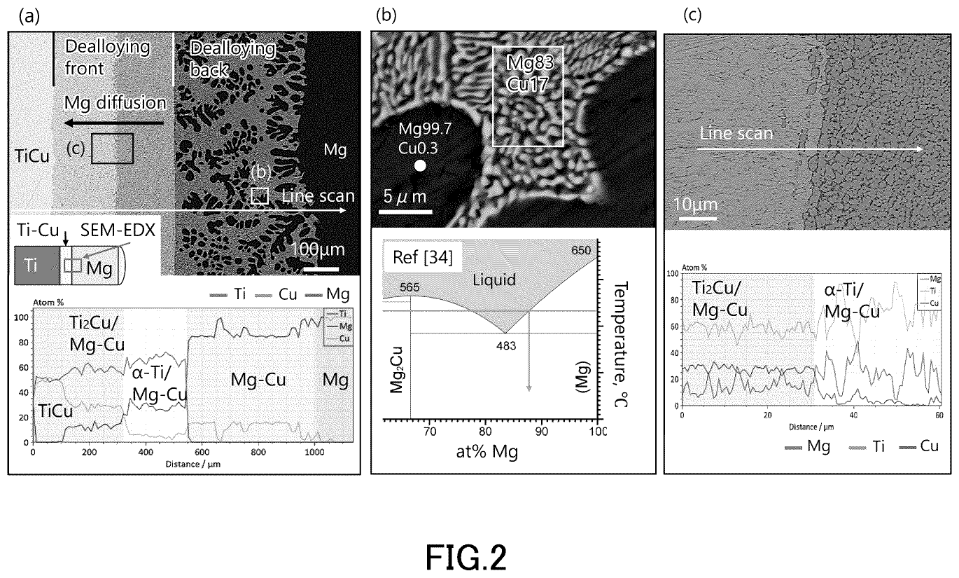

Subsequently, an SEM observation and an EDX analysis were performed in the vicinity of the bonded interface between Ti₁₀₀₋ₓCuₓ and Mg in the second stage. FIG. 2(a) shows the SEM image and the EDX analysis result in the vicinity of the bonded interface under the condition of x=50, at a heating temperature of 803 K, at a bonding pressure of 5 MPa, for a retention time of 15 minutes. FIG. 2(a) shows a state that a TiCu layer, a Ti₂Cu/Mg—Cu phase, an α-Ti/Mg—Cu phase, an Mg—Cu phase, and an Mg layer are layered in this order from the left to the right. FIG. 2(b) shows an enlarged SEM image of a solidified microstructure including a dendrite-like primary crystal in the Mg—Cu phase, as observed in FIG. 2(a). FIG. 2(c) shows an enlarged SEM image of a region on the boundary between the Ti₂Cu/Mg—Cu phase and the α-Ti/Mg—Cu phase observed in FIG. 2(a), and an EDX analysis result.

As a result of performing the EDX compositional analysis of the solidified microstructure including the primary crystal shown in FIG. 2(b), it was confirmed that the fine two-phase microstructure contained 83 at % of Mg and 17 at % of Cu, and the coarse phase contained 99.7 at % of Mg and 0.3 at % of Cu. These compositions can be confirmed from the Cu—Mg binary equilibrium diagram in the figure (see Alloy Phase Diagram Database (ASM), Copper-Magnesium Binary Phase Diagram (2008 Miettien J.), 2024, https://matdata.asminternational.org/apd/index.aspx). That is, when Mg and Cu are butt-joined and bonded to each other at 803 K, a eutectic reaction occurs on the interface therebetween, resulting in a molten Mg—Cu. Subsequently, as the temperature decreases, this melt solidifies to first cause formation of a primary α-Mg crystal, followed by formation of a eutectic crystal between Mg₂Cu and α-Mg. When this finding is applied to the observation result in FIG. 2(b), it is considered that eutectic melting is also caused on the bonded interface between Ti₅₀Cu₅₀ and Mg.

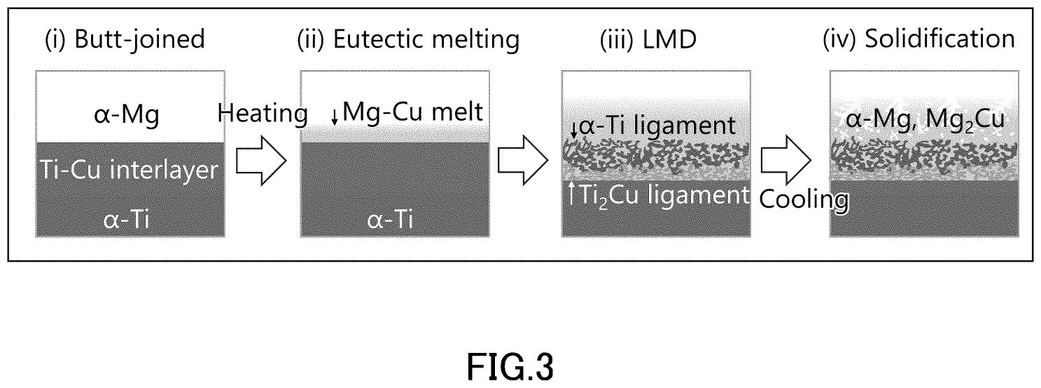

Based on the results shown in FIG. 2, the reactions in the second stage are summarized, and the summarized result is shown in FIG. 3. As shown in FIG. 3, first, the Ti—Cu (Ti—Cu interlayer) sample provided on the surface of Ti (α-Ti) and the Mg (α-Mg) sample are butt-joined to each other at a predetermined pressure [Step (i)]. When heat treatment is performed while maintaining this state, solid-phase diffusion is caused on the contact interface, and Cu and Mg are interdiffused with each other. As this interdiffusion progresses, a eutectic reaction occurs on the contact interface and the circumference thereof, to produce an Mg—Cu melt [Step (ii)]. Furthermore, Cu in the Ti—Cu sample dissolves into the produced melt, and the Mg—Cu melt diffuses to the Ti—Cu side. At this time, within the range where Mg has diffused in the Ti—Cu sample, the Ti-containing phases link with each other, and the Mg—Cu melt occupies spaces between the Ti-containing phases while maintaining their continuity. In this way, the continuous structure with the Mg—Cu melt permeating between the Ti-containing phases is self-organized [Step (iii)]. When the Mg—Cu melt is cooled and solidified, a co-continuous microstructure with the Ti-containing phases and the Mg—Cu phases intertangled with each other on the order of nanometers or micrometers, and a layer composed of Mg—Cu phases are formed [Step (iv)].

In the results shown in FIG. 2, since the bonded interface still contains the brittle phases such as Mg₂Cu, the bond strength may be decreased. Thus, the bonding experiment between Ti₁₀₀₋ₓCuₓ and Mg was implemented while varying the bonding pressure during the heat treatment in the second stage. The experiment was implemented for each case of x=33, 50, and 65, under conditions that the heating temperature in the second stage was 813 K, the retention time was 30 minutes, the bonding pressure was 0 MPa, 1 MPa, 5 MPa, 10 MPa, or 20 MPa. After the bonding under each condition, the thickness of the layer composed of the Mg—Cu phase was measured.

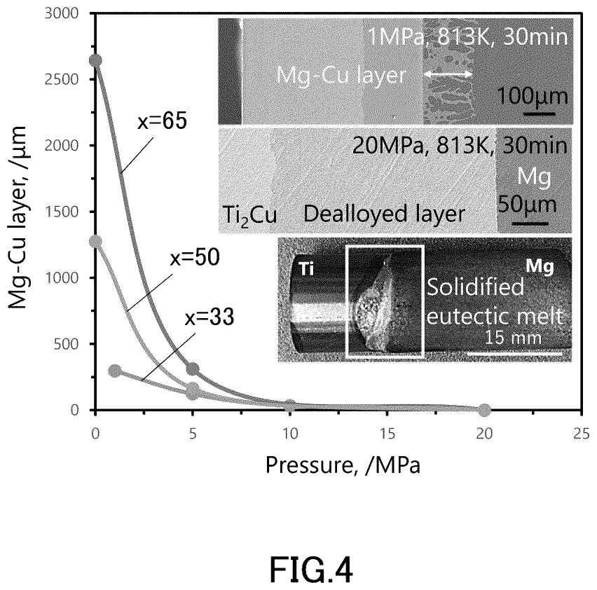

FIG. 4 shows a change in a thickness of a layer composed of the Mg—Cu phase (Mg—Cu layer) relative to the bonding pressure. The insert image in FIG. 4 includes an SEM image in the vicinity of the bonded interface at a bonding pressure of 1 MPa, an SEM image in the vicinity of the bonded interface at a bonding pressure of 20 MPa, and an appearance of a lateral face after cooling at a bonding pressure of 20 MPa, under a condition of X=33.

As shown in FIG. 4 and the insert image, as the bonding pressure increases, the layer composed of the Mg—Cu phase (Mg—Cu layer) becomes thinner. It was confirmed that, at 10 MPa, almost no layer composed of the Mg—Cu phase remained, and at 20 MPa, none remained at all. Furthermore, as shown in the insert image of FIG. 4, it was confirmed that, after cooling, the Mg—Cu melt adhered to the periphery of the bonded body and solidified. These results suggest that the liquid alloy composed of the Mg—Cu melt can be discharged to the outside from the bonded interface by applying a predetermined pressure during heat treatment, and the amount of the discharged Mg—Cu melt can be increased by increasing the bonding pressure. Thereby, formation of the brittle phases such as Mg₂Cu is prevented after cooling, and therefore a decrease in the bond strength on the bonding face may be prevented. Also, it was confirmed that, in the layer with the Ti-containing phase and the Mg—Cu phase intertangled with each other, the Mg—Cu phase remained regardless of the pressure.

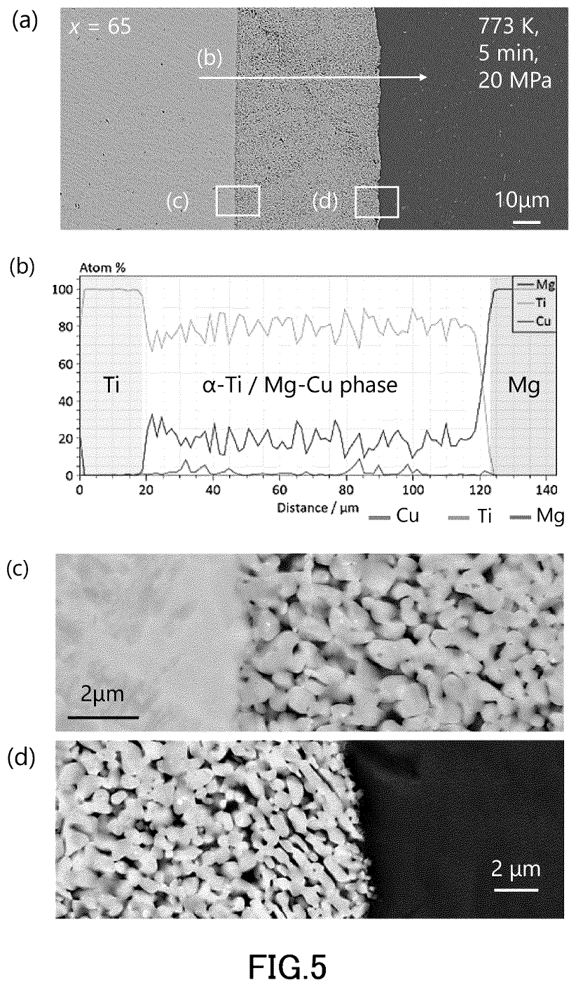

Subsequently, a bonding experiment between Ti₁₀₀₋ₓCuₓ and Mg was implemented for the case of x=65 under a condition that the heating temperature in the second stage was 773 K, the retention time was 5 minutes, the bonding pressure was 20 MPa. The SEM image and the EDX analysis result in the vicinity of the bonded interface after the bonding are shown in FIG. 5(a) and FIG. 5(b) respectively. Enlarged SEM images of the regions (c) and (d) in FIG. 5(a) are shown in FIG. 5(c) and FIG. 5(d) respectively.

As shown in FIG. 5(a) and FIG. 5(b), it was confirmed that the entire Ti₁₀₀₋ₓCuₓ layer between Ti and Mg was dealloyed, and Ti and Mg were bonded to each other only by a co-continuous microstructure composed of an α-Ti/Mg—Cu phase without any brittle phase. As shown in FIG. 5(c), no cracks representing metal bonds were observed between pure Ti and the co-continuous microstructure. As shown in FIG. 5(d), no layer composed of Mg—Cu phase was observed between the co-continuous microstructure and Mg.

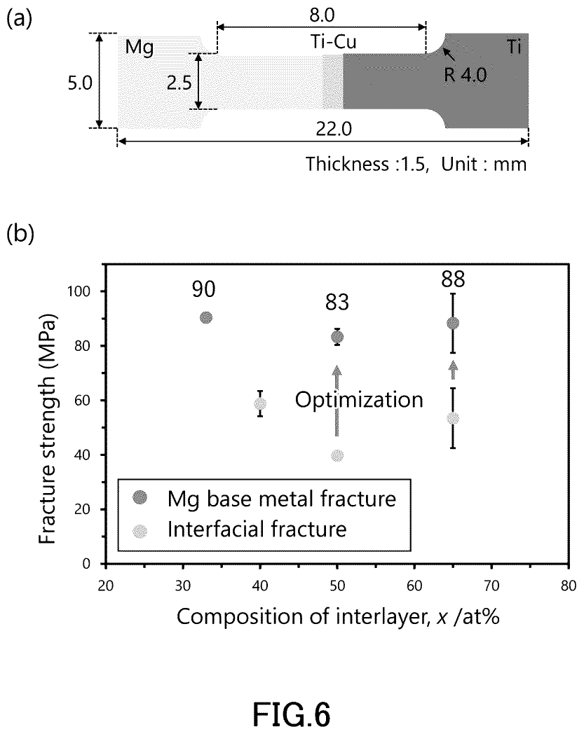

Next, Ti₁₀₀₋ₓCuₓ and Mg were bonded to each other for the case of x=33, 40, 50, and 65 under conditions that the heating temperature in the second stage was 773 K to 813 K, the retention time was 5 to 30 minutes, the predetermined pressure was 0.2 MPa or 20 MPa. Each of the bonded bodies after the bonding was subjected to a tensile test. In the tensile test, specimens were cut out into the shape shown in FIG. 6(a) using a wire electric discharge machine. The tensile test was implemented using “AG50VF” manufactured by Shimadzu Corporation at a strain rate of 5.0×10⁻⁴ (s⁻¹) (the same applies to the following). For each sample, the tensile test was repeated three times, the average value was calculated as the test result. The tensile test result is shown in FIG. 6(b).

As shown in FIG. 6(b), it was confirmed that the fracture strength was 39.8 MPa to 58.7 MPa under the condition of x=40 at 0.2 MPa, under the condition of x=50 at 0.2 MPa, and under the condition of x=65 at 0.2 MPa (“Interfacial fracture” in the figure). Also, it was confirmed that the fracture position was located on the layer composed of the Mg—Cu phase in the vicinity of the bonded interface and on its boundary surface. In contrast, it was confirmed that the fracture strength was 83.3 MPa to 90.3 MPa under the condition of x=33 at 20 MPa, under the condition of x=50 at 20 MPa, and under the condition of x=65 at 20 MPa, and the specimen was fractured inside Mg (“Mg base metal fracture” in the figure). These results suggest that the bond strength on the bonding face can be increased by increasing the bonding pressure. Also, it was confirmed that this bond strength was higher than the strength of Mg itself.

Subsequently, the co-continuous microstructure composed of Ti, Mg, and α-Ti/Mg—Cu phase in the bonded body formed for the case of x=50 under conditions that the heating temperature in the second stage was 803 K, the retention time was 15 minutes, the predetermined pressure was 20 MPa was subjected to a hardness measurement using an ultra-microhardness tester (“ENT-1100b” manufactured by ELIONIX INC.). In the measurement, the maximum load was set to 200 mN, and the interval between indentations was set to larger than 10 μm for avoiding the influence of work hardening. Furthermore, the measurement was repeated five times for each measurement specimen, and an average value was calculated.

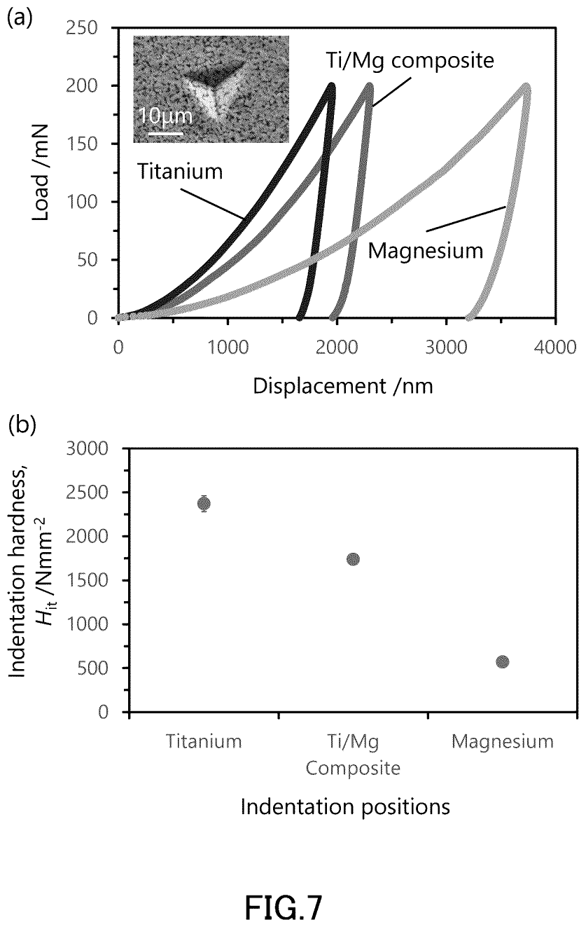

FIG. 7(a) shows a load-displacement curve measured by an ultra-microhardness tester for the co-continuous microstructure composed of Ti, Mg, and α-Ti/Mg—Cu phase, and the insert image shows a microscopic photograph of indenter marks on the co-continuous microstructure (“Ti/Mg composite” in the figure). FIG. 7(a) shows the smooth load-displacement curves in all structures, indicating an elastoplastic behavior. Furthermore, as shown in the insert image, no cracks propagating from the peak of the indenter mark were observed, indicating that the co-continuous microstructure was not brittle.

Based on the results of the measurement using the ultra-microhardness tester, the indentation hardness Hᵢₜ values were calculated and shown in FIG. 7(b). As shown in FIG. 7(b), it was confirmed that the indentation hardness Hᵢₜ value of the co-continuous microstructure was located between the indentation hardness Hᵢₜ values of Ti and Mg. According to ISO 14577, there is a correlation between Hᵢₜ and Vickers hardness (HV), and therefore the co-continuous microstructure is considered to have a middle strength between the strengths of Ti and Mg.

### Example 2

A bonding experiment between Fe₁₀₀₋ₓNiₓ (x=50) provided on a surface of carbon steel S45C (manufactured by ASANO STEEL K.K.) and KUMADAI magnesium alloy (Mg—Zn—Y alloy; manufactured by FUJI LIGHT METAL CO., LTD.) was implemented using the method for manufacturing a metal solid-to-metal solid bonded body according to the embodiment of the present invention. In this experiment, the first component is Mg, the second component is Fe, and the third component is Ni. In the experiment, an S45C sample and KUMADAI magnesium alloy sample having a diameter of 15 mm and a thickness of 15 mm, as well as an Fe₁₀₀₋ₓNiₓ sample having a thickness of 0.1 mm were prepared. The Fe₁₀₀₋ₓNiₓ sample was prepared by an arc melting of Fe and Ni and a tilt casting into a round bar copper mold, followed by rolling.

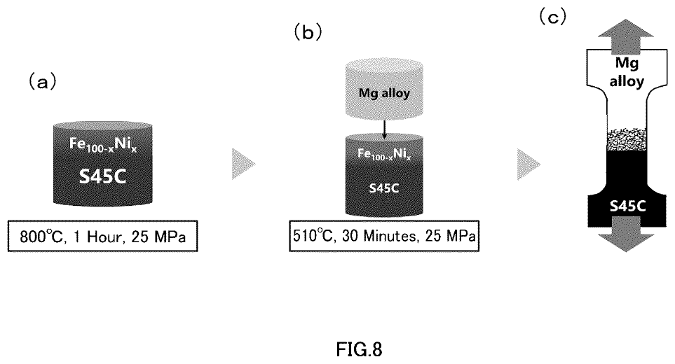

In the experiment, in the first stage, as shown in FIG. 8(a), one surface of the S45C sample and one surface of the Fe₁₀₀₋ₓNiₓ sample were butt-joined to each other at a pressure of 25 MPa, and in this state, the samples were hot-pressed at 800° C. (1073 K) for 1 hour to bond the S45C sample and the Fe₁₀₀₋ₓNiₓ sample to each other. Subsequently, in the second stage, as shown in FIG. 8(b), the other surface of the Fe₁₀₀₋ₓNiₓ sample and one surface of the KUMADAI magnesium alloy sample were butt-joined to each other at a bonding pressure of 25 MPa, and in this state, the samples were heated at 510° C. (783 K) for 30 minutes to bond the Fe₁₀₀₋ₓNiₓ sample and the KUMADAI magnesium alloy sample to each other. Then, as shown in FIG. 8(c), a tensile test was implemented to investigate the bond strength therebetween.

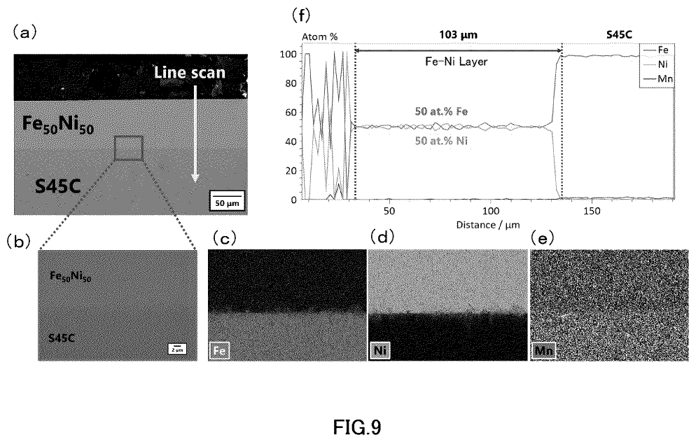

First, in the vicinity of the bonded interface after the hot pressing between the S45C sample and the Fe₁₀₀₋ₓNiₓ sample in the first stage, an SEM observation and an EDX analysis were performed. The SEM images in the vicinity of the bonded interface are shown in FIG. 9(a) and FIG. 9(b), the results of the EDX surface analysis are shown in FIG. 9(c) to FIG. 9(e), and the results of the EDX line analysis are shown in FIG. 9(f). As shown in FIG. 9, the S45C sample and the Fe₁₀₀₋ₓNiₓ sample were directly bonded to each other, and no intermetallic compounds were observed in the vicinity of the bonded interface.

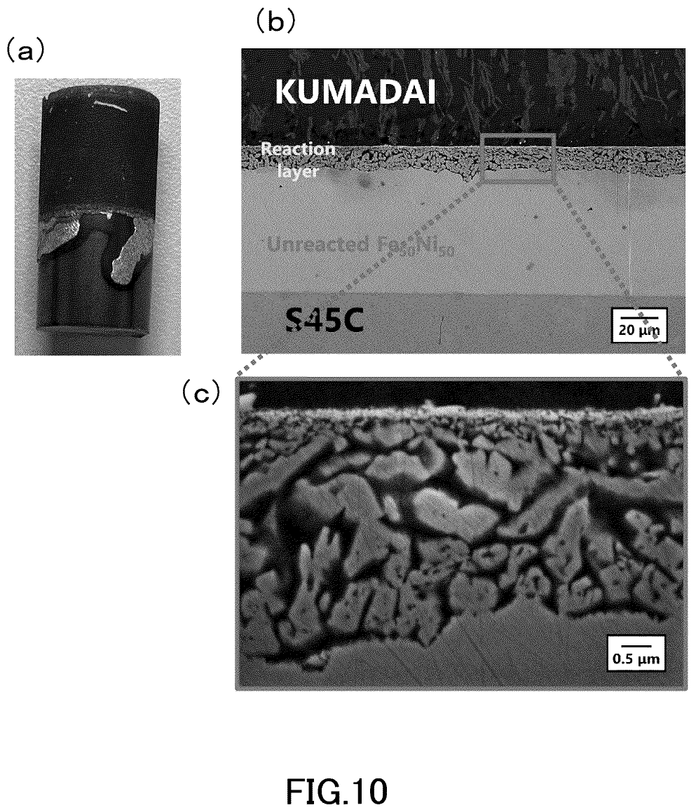

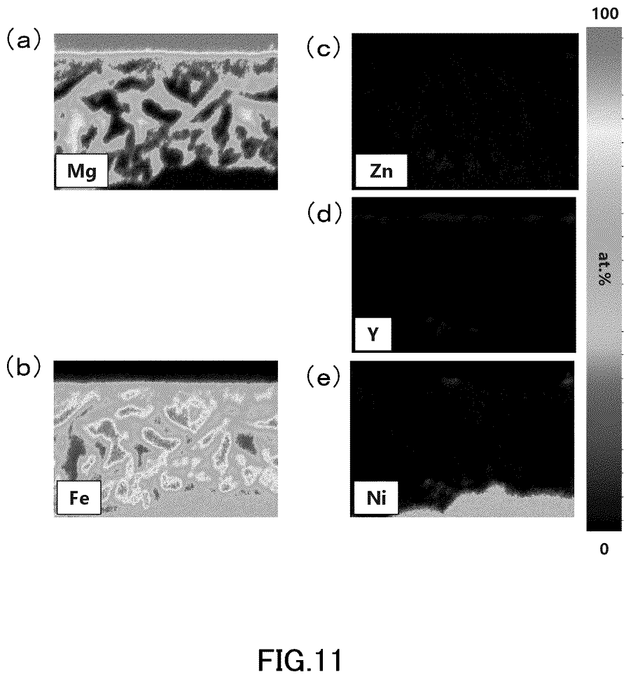

Subsequently, an SEM observation and an EDX analysis were performed in the vicinity of the bonded interface between the Fe₁₀₀₋ₓNiₓ sample and the KUMADAI magnesium alloy sample in the second stage. FIG. 10(a) shows the appearance of the bonded body after the bonding (cooling), and FIG. 10(b) and FIG. 10(c) show SEM images in the vicinity of the bonded interface. FIG. 11(a) to FIG. 11(e) show EDX analysis results. As shown in FIG. 10(b), FIG. 10(c), and FIG. 11, formation of a fine composite structure (“Reaction layer” in the figure) composed of the Fe—Mg phase was confirmed on the bonded interface. No formation of intermetallic compounds such as Mg—Ni phase was observed. As shown in FIG. 10(a), it was confirmed that, after cooling, the Mg—Ni melt adhered to the periphery of the bonded metal components and solidified.

These results suggest that the liquid alloy composed of the Mg—Ni melt can be discharged to the outside from the bonded interface by applying a pressure during the heat treatment. Thereby, formation of the brittle phases such as Mg₂Ni is prevented after cooling, and therefore a decrease in the bond strength on the bonding face may be prevented.

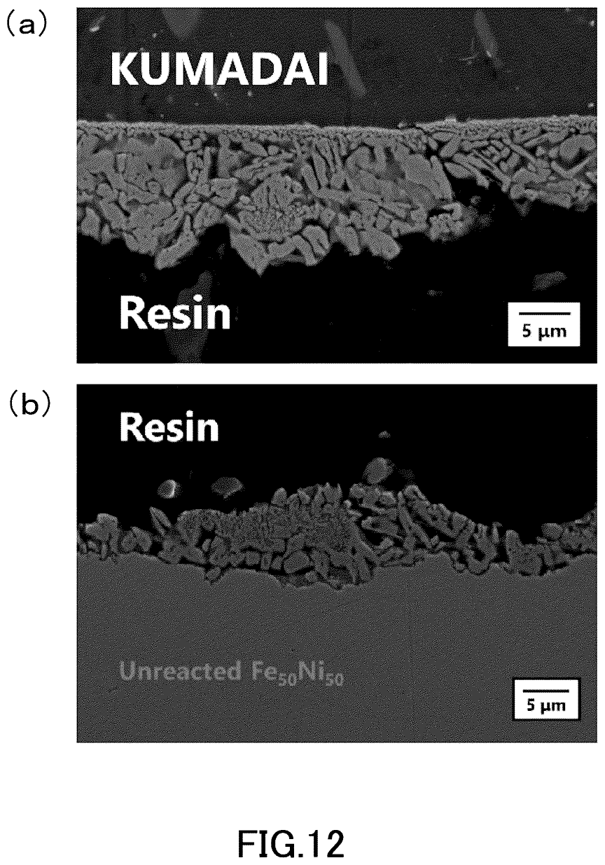

Subsequently, the bonded bodies after the bonding were subjected to a tensile test. In the tensile test, specimens were cut out into the shape shown in FIG. 6(a) and tested three times. The tensile strengths in the three tests were 193 MPa, 160.4 MPa, and 142 MPa, and their average value was 165 MPa. FIG. 12(a) and FIG. 12(b) show, as examples, SEM images of the specimens at the position where the specimen has been fractured in the tensile test. As shown in FIG. 12, it was confirmed that the specimen had been fractured inside the fine composite structure composed of the Fe—Mg phase formed on the bonded interface in the tensile test.

### Example 3

A bonding experiment between a Ti₁₀₀₋ₓCuₓ (x=50, 65) sample and a magnesium alloy ZK60 (Mg—Zn—Zr alloy) sample was implemented using the method for manufacturing a metal solid-to-metal solid bonded body according to the embodiment of the present invention. In this experiment, the first component was Mg, the second component was Ti, and the third component was Cu. The surface of the Ti₁₀₀₋ₓCuₓ sample and the surface of the ZK60 sample were butt-joined to each other at a bonding pressure of 20 MPa, and in this state, the samples were heated at 540° C. (813 K) for 5 minutes to bond the Ti₁₀₀₋ₓCuₓ sample and the ZK60 sample to each other.

As a result of a tensile test for the bonded body after the bonding, the tensile strength was 240 MPa, and it was confirmed that the specimen had been fractured on the layer composed of the Mg—Cu phase formed on the bonded interface, and its boundary surface. These results suggest that the liquid alloy composed of the Mg—Cu melt can be discharged to the outside from the bonded interface by applying a pressure during the heat treatment, to prevent a decrease in the bond strength on the bonding face.

In the bonded body after the bonding, a magnesium alloy AZ31 (Mg—Al—Zn alloy) sample was bonded to the surface of the ZK60 sample opposite to the Ti₁₀₀₋ₓCuₓ side by diffusion bonding. Thereby, Ti₁₀₀₋ₓCuₓ and AZ31 directly unbondable with each other could be bonded to each other via ZK60.

1. A method for manufacturing a metal solid-to-metal solid bonded body, wherein a solid metal body containing a first component is brought into contact with a solid metal material composed of a compound, an alloy, or a non-equilibrium alloy, which contains both a second component and a third component having positive and negative heats of mixing respectively relative to the first component, and heated at a predetermined temperature for a predetermined time while applying a predetermined pressure between the metal body and the metal material, so that the first component and the third component are interdiffused with each other, and a liquid alloy containing the first component and the third component, which has been generated in a region where the first component and the third component have interdiffused with each other, is discharged.

2. The method according to claim 1, wherein the liquid alloy is produced by a eutectic reaction between the first component and the third component in a region where the first component and third component have interdiffused with each other.

3. The method according to claim 1, wherein
the liquid alloy has a melting point lower than a melting point of the metal body, and
the predetermined temperature is lower than melting points of the metal body and the metal material and higher than a melting point or liquidus temperature of the liquid alloy.

4. The method according to claim 1, wherein the liquid alloy contains what becomes, after solidification, an intermetallic compound containing the first component and the third component bonded to each other.

5. The method according to claim 1, wherein the liquid alloy does not contain the second component.

6. The method according to claim 1, wherein the predetermined pressure is 10 MPa or higher.

7. The method according to claim 1, wherein
the first component is composed of at least one of Li, Mg, Ca, Cu, Zn, Ag, Pb, Bi, and a rare earth metal element,
the metal body is composed of the first component alone, or a mixture that is an alloy, a compound, or a non-equilibrium alloy, which contains the first component as a main component,
the second component is composed of at least one of Ti, Zr, Hf, Nb, Ta, Cr, V, Mo, W, Fe, Co, Ni, C, Si, Ge, and Sn,
the third component is composed of at least one of Li, Mg, Ca, Mn, Fe, Co, Ni, Cu, Ti, Zr, Hf, Nb, Ta, Cr, Mo, and W, and
the metal material is composed of a mixture that is an alloy, a compound, or a non-equilibrium alloy, which contains both the second component and the third component.

8. The method according to claim 1, wherein
the first component is composed of Mg,
the metal body is composed of the first component alone, or a mixture that is an alloy, a compound, or a non-equilibrium alloy, which contains the first component as a main component,
the third component is composed of Ni, and
the metal material is an Fe-containing alloy.

9. The method according to claim 1, wherein
the first component is composed of Mg,
the metal body is composed of the first component alone, or a mixture that is an alloy, a compound, or a non-equilibrium alloy, which contains the first component as a main component,
the third component is composed of Cu, and
the metal material is a Ti-containing alloy.

10. A method for manufacturing a bonded body, wherein a solid metal body containing Mg or an Mg alloy is brought into contact with a solid metal material containing an Ni and Fe-containing alloy or a Ti and Cu-containing alloy, and the metal body and the metal material are heated while applying a pressure to between the metal body and the metal material to bond the metal body and the metal material to each other.

11. The method according to claim 10, wherein
the metal body is an alloy containing Mg, Zn, and Y or Zr, or an alloy containing Mg, Al, and Zn, and
the metal material contains Fe₁₀₀₋ₓNiₓ (30≤x≤70, unit: at %), or Ti_{100-y}Cu_{y} (30≤y≤70, unit: at %).

12. The method according to claim 11, wherein
an Fe alloy or Ti alloy is bonded to the metal material such that the metal material is interposed between the metal body and the alloy, and/or
a metal or alloy having a composition different from that of the metal material and containing at least one of Mg, Zn, Y, Zr, and Al is bonded to the metal body such that the metal body is interposed between the metal material and the metal or alloy.

13. The method according to claim 12, wherein the Fe alloy is carbon steel or stainless steel.

14. The method according to claim 12, wherein the Ti alloy contains Ti and at least one of Al, V, Nb, Ni, Cr, and Sn.

15. A composite member having:
a solid metal body containing a first component; and
a co-continuous structure with a portion containing the first component and a third component having a negative heat of mixing relative to the first component and a portion containing a second component having a positive heat of mixing relative to the first component, the portions intertangled with each other on the order of nanometers or micrometers, wherein
the co-continuous structure is bonded to a surface of the metal body.

16. The composite member according to claim 15, having
a solid metal material composed of a compound, an alloy, or a non-equilibrium alloy containing both the second component and the third component, wherein
the metal material is bonded to the metal body such that the co-continuous structure is interposed between the metal material and the metal body.

17. The composite member according to claim 15, wherein the third component is composed of a material that is eutectically reactable with the first component at a temperature lower than a melting point of the metal body.

18. The composite member according to claim 15, wherein
the first component is composed of at least one of Li, Mg, Ca, Cu, Zn, Ag, Pb, Bi, and a rare earth metal element,
the metal body is composed of the first component alone, or a mixture that is an alloy, a compound, or a non-equilibrium alloy, which contains the first component as a main component,
the second component is composed of at least one of Ti, Zr, Hf, Nb, Ta, Cr, V, Mo, W, Fe, Co, Ni, C, Si, Ge, and Sn, and
the third component is composed of at least one of Li, Mg, Ca, Mn, Fe, Co, Ni, Cu, Ti, Zr, Hf, Nb, Ta, Cr, Mo, and W.

19. The composite member according to claim 16, wherein
the first component is composed of Mg,
the metal body is composed of the first component alone, or a mixture that is an alloy, a compound, or a non-equilibrium alloy, which contains the first component as a main component,
the third component is composed of Ni, and
the metal material is an Fe-containing alloy.

20. The composite member according to claim 16, wherein
the first component is composed of Mg,
the metal body is composed of the first component alone, or a mixture that is an alloy, a compound, or a non-equilibrium alloy, which contains the first component as a main component,
the third component is composed of Cu, and
the metal material is a Ti-containing alloy.

21. The composite member according to claim 19, wherein
the metal body is an alloy containing Mg, Zn, and Y or Zr, or an alloy containing Mg, Al, and Zn, and
the metal material contains Fe₁₀₀₋ₓNiₓ (30≤x≤70, unit: at %), or Ti_{100-y}Cu_{y} (30≤y≤70, unit: at %).

22. The composite member according to claim 21, having:
an Fe alloy or Ti alloy bonded to the metal material such that the metal material is interposed between the metal body and the alloy; and/or
a metal or an alloy with a composition different from that of the metal material, which is bonded to the metal body such that the metal body is interposed between the metal material and the metal or the alloy, the metal or alloy containing at least one of Mg, Zn, Y, Zr, and Al.

23. The composite member according to claim 22, wherein the Fe alloy is carbon steel or stainless steel.

24. The composite member according to claim 22, wherein the Ti alloy contains Ti and at least one of Al, V, Nb, Ni, Cr, and Sn.
